(19) United States
(12) Patent Application Publication
(10) Pub. No.: US 2019/0174738 A1
(43) Pub. Date: Jun. 13, 2019

(54) SEED TRAIT VERIFICATION FOR MONITORING HERBICIDE APPLICATIONS ON NON-RESISTANT VARIETIES AND CROPS

(71) Applicant: AGRIAN, INC., Clovis, CA (US)

(72) Inventors: AARON DALE HUNT, BELLEFONTE, PA (US); PETER H. BRANDT, FRIANT, CA (US); NISHAN MAJARIAN, CLOVIS, CA (US); SPYROS J. LAZARIS, LOS ANGELES, CA (US)

(21) Appl. No.: 16/213,765

(22) Filed: Dec. 7, 2018

Related U.S. Application Data
(60) Provisional application No. 62/595,709, filed on Dec. 7, 2017.

(51) Int. Cl. A01M 7/00; G05B 19/042; G05B 13/02; A01B 79/00; G05D 7/06

(52) U.S. Cl. CPC A01M 7/0089; G05B 19/0428; G05B 2219/25252; A01B 79/005; G05D 7/0617; G05B 13/0265

(57) ABSTRACT

A framework for validating resistance traits in seed varieties in planted crops and monitoring crop treatments applied in planted fields ensures that an herbicide is not used on a non herbicide-resistant crop. A user provides a recommendation for a selected herbicide, and the framework performs seed trait analytics by gathering seed variety information in planting data and seed resistance traits in the planted seed variety, as well as active ingredients and any specific amounts thereof in the selected herbicide. If the seed variety is resistant to the proposed herbicide, the verification framework outputs a recommendation to proceed with the application. If the seed variety is not resistant to the proposed herbicide, then the verification framework outputs a warning to the user of a risk with proceeding with the application. The framework also checks the proposed herbicide application against resistance traits in seed varieties in crops planted in neighboring fields and produces outputs for mitigation drift issues where there is a non-resistance variety in that neighboring field.

### CROSS-REFERENCE TO RELATED PATENT APPLICATION(S)

This patent application claims priority to U.S. provisional application 62/595,709, filed on Dec. 7, 2017, the contents of which are incorporated in their entirety herein. In accordance with 37 C.F.R. § 1.76, a claim of priority is included in an Application Data Sheet filed concurrently herewith.

### FIELD OF THE INVENTION

The present invention relates to seed trait analytics. Specifically, the present invention relates to a system and method of preventing an application of an herbicide or other toxic chemical substance on plants and crops having non herbicide-resistant seed varieties.

### BACKGROUND OF THE INVENTION

Many seed varieties are currently available that contain traits that make them resistant to certain kinds of pesticides and other toxic chemical substances (and in particular, herbicides). Resistant traits in a particular seed variety are targeted by agronomists so that the resulting planted crop will be resistant to certain active ingredients in herbicides. This allows those herbicides to be applied overtop the planted crop and yet not affect the crop its self, and only targeting the pest.

However, active ingredient-resistant seed traits are often hidden under many different marketing or trade names by manufacturers. The same is true for the active ingredients in chemical herbicides. Different active ingredients can be produced under many different names, or mixed in with other active ingredients and sold under other names. This can make it very hard to match what herbicide can be applied to what crop in a particular field. Additionally, many active ingredients in herbicides affect crops depending on their specific amounts, and interactions with other ingredients (active or otherwise) in crop treatments, making it difficult to determine whether a crop will actually be resistant to crop treatments to be applied.

When an agronomist is making a chemical application recommendation using a pesticide, insecticide, herbicide, or other toxic substance, or an applicator is in the field ready to make an application, they need to ensure that the chemicals they are intending to recommend or apply can be safely introduced to the crop in that field. If the agronomist or applicator does not perform an analysis of the active ingredients associated with the seed resistance traits to make sure the seed variety is resistant to the herbicide active ingredient, there is a risk of harming or killing the crop.

In addition, they may also need the check to make sure that crops planted in neighboring or nearby fields are also not susceptible to the intended herbicide, for example where there is a possible drift issue. If a neighboring crop is susceptible to the herbicide, damage or death could happen to that crop as well. Therefore, this is a large liability risk to the agronomist, applicator and grower when recommending or applying a pesticide.

### BRIEF SUMMARY OF THE INVENTION

The present invention is an approach to preventing an application of herbicide on crops and plants from non-resistant seed varieties to ensure that an herbicide is not used on a non herbicide-resistant crop. In such an approach, an index of active ingredients for all herbicides in an herbicide or chemical database, and all active ingredient resistance traits for seed varieties in a chemical and a seed variety database, are checked against a planting event and seed variety recorded by a grower, agronomist, or other responsible party. A seed trait verification can then be performed using this information to ensure that the planting event does not result in an herbicide being unknowingly used on a non herbicide-resistant crop.

It is therefore one objective of the present invention to provide a system and method of protecting crop and plant health, and for improving food safety. It is another objective of the present invention to provide a system and method of preventing an application of herbicide on crops and plants with non-resistant seed varieties. It is still another objective of the present invention to provide an approach for enabling an agronomist to evaluate an herbicide application and provide either an approval or a warning of risk. It is yet another objective of the present invention to provide an applicator check that provides an in-cab display in agricultural equipment whether a selected plant variety is resistant or not resistant to a proposed herbicide application. It is another objective of the present invention to provide a system and method of preventing herbicide contamination in neighboring or nearby fields having crops and plants with non-resistant seed varieties.

In one embodiment, the present invention is a method, comprising receiving, as input data, a selected herbicide for an anticipated application in a particular field, information representing one or more active ingredients for the selected herbicide, planting data that includes a seed variety planted in the particular field, and seed resistance traits in the seed variety; analyzing the input data in a plurality of data processing modules within a computing environment in which the plurality of data processing modules are executed in conjunction with at least one processor, the data processing modules configured to validate the anticipated application of the selected herbicide in the particular field, by: identifying a specific amount of the one or more active ingredients to be delivered in the anticipated application of the selected herbicide in the particular field, associating a resistance of the seed variety to the specific amount of the one or more active ingredients from the seed resistance traits to determine a compatibility of the selected herbicide with the seed variety for enabling a crop treatment for the particular field, and generating a resistance profile characterizing the anticipated application of the selected herbicide to the particular field based on the compatibility of the selected herbicide with the seed variety; and initiating a stop operation from the resistance profile characterizing the anticipated application of the selected herbicide to the particular field where the resistance profile characterizes the seed variety as not resistant to the selected herbicide, and a proceed operation from the resistance profile characterizing the anticipated application of the selected herbicide to the particular field where the resistance profile characterizes the seed variety as resistant to the selected herbicide, wherein a user stops or proceeds with an herbicide application in the particular field based on the anticipated application of the selected herbicide to the particular field, or an automated stop or proceed is controlled based on the anticipated application of the selected herbicide to the particular field.

In another embodiment, the present invention is a system, comprising a computing environment including at least one non-transitory computer-readable storage medium having program instructions stored therein and a computer processor operable to execute the program instructions to validate an anticipated application of a selected herbicide in a particular field within a plurality of data processing components, the plurality of data processing components including a data retrieval and initialization component configured to receive, as input data, the selected herbicide for the anticipated application in the particular field, information representing one or more active ingredients for the selected herbicide, planting data that includes a seed variety planted in the particular field, and seed resistance traits in the seed variety; one or more components configured to identify a specific amount of the one or more active ingredients to be delivered in the anticipated application of the selected herbicide in the particular field, associating a resistance of the seed variety to the specific amount of the one or more active ingredients from the seed resistance traits to determine a compatibility of the selected herbicide with the seed variety for enabling a crop treatment for the particular field, and generating a resistance profile characterizing the anticipated application of the selected herbicide to the particular field based on the compatibility of the selected herbicide with the seed variety; and an output component configured to initiate a stop operation from the resistance profile characterizing the anticipated application of the selected herbicide to the particular field where the resistance profile characterizes the seed variety as not resistant to the proposed herbicide, and a proceed operation from the resistance profile characterizing the anticipated application of the selected herbicide to the particular field where the resistance profile characterizes the seed variety as resistant to the proposed herbicide, wherein a user stops or proceeds with an herbicide application in the particular field based on the anticipated application of the selected herbicide to the particular field, or an automated stop or proceed is controlled based on the anticipated application of the selected herbicide to the particular field.

Other objects, embodiments, features, and advantages of the present invention will become apparent from the following description of the embodiments, taken together with any accompanying drawings, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a diagram illustrating system components in a framework for verifying seed resistance traits for an anticipated application of a selected herbicide according to one embodiment of the present invention;

FIG. 2 is a block diagram illustrating aspects of the framework for verifying seed resistance traits for an anticipated application of a selected herbicide according to another embodiment of the present invention; and

FIG. 3 is a block diagram illustrating aspects of the framework for verifying seed resistance traits for an anticipated application of a selected herbicide according to yet another embodiment of the present invention.

### DETAILED DESCRIPTION OF THE INVENTION

In the following description of the present invention, reference is made to the exemplary embodiments illustrating the principles of the present invention and how it is practiced. Other embodiments will be utilized to practice the present invention and structural and functional changes will be made thereto without departing from the scope of the present invention.

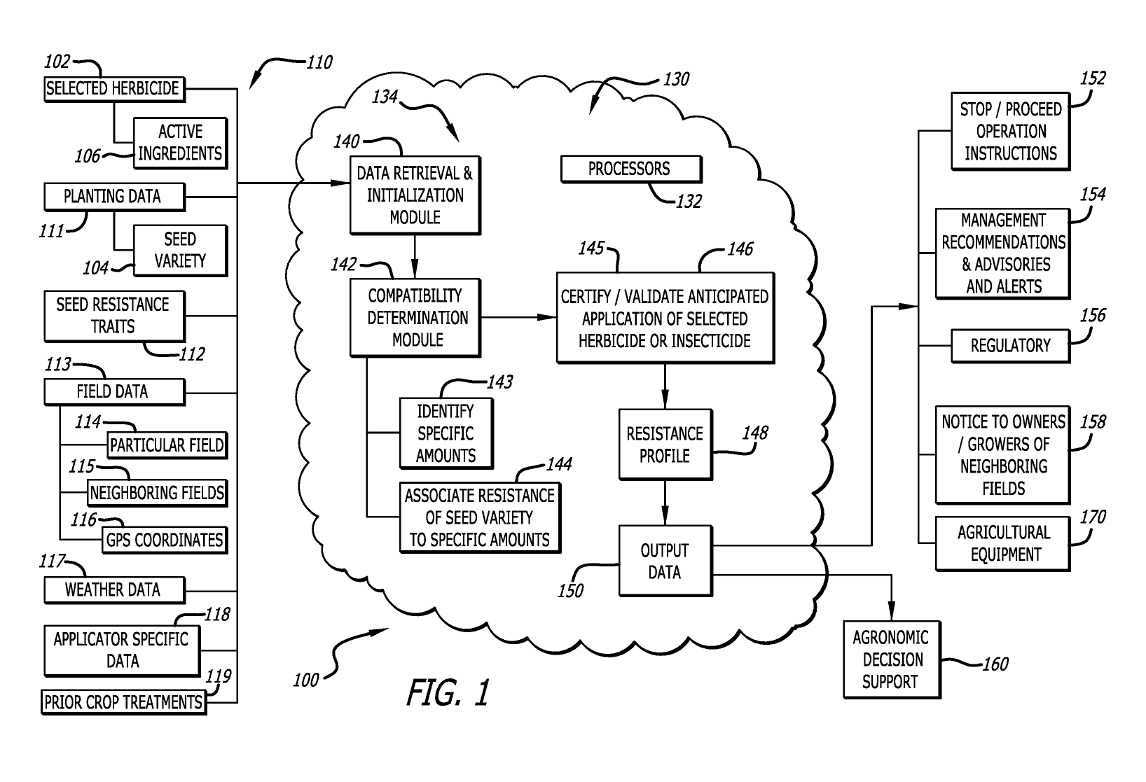

The present invention is a framework for seed trait verification 100 for determining whether a seed variety 104 in a planted field is resistant or not resistant to a recommended or proposed application of an herbicide, insecticide or pesticide 102 (which may collectively referred to herein as an “herbicide” or “herbicides”). FIG. 1 is a systemic diagram illustrating various components in such a framework for seed trait verification 100.

Input data 110 for the framework for seed trait verification 100 is processed using a plurality of data processing functions, within a computing environment 130 that includes one or more processors 132 and a plurality of software and hardware components. The one or more processors and plurality of software and hardware components may be organized as dedicated modules 134 for performing specific ones of the plurality data processing functions, and regardless are configured to execute program instructions or routines embodied within the dedicated modules 134 configured to carry out the data processing functions described herein. Seed trait verification 100 according to the present invention ensures that an herbicide 102 is not used on a non herbicide-resistant crop, for improvements in crop and plant health, and in food and consumer safety.

In the present invention, at any time after a planting event has been recorded, a grower or agronomist may decide that an application of herbicide, insecticide or pesticide 102 is needed for a crop in a particular field 114. As application data is entered into the present invention and the intended herbicide for use is selected, the framework for seed trait verification 100 performs seed trait analytics to check against planting data 111 and other relevant types of input data 110. The framework for seed trait verification 100 looks at the different active ingredients 106 in the selected herbicide 102, as well as specific amounts thereof, and compares those to the active ingredient-resistant seed traits 112 for the seed variety 104 recorded in the planting data 111.

If there is an active ingredient 106 in the selected herbicide 102 that is not covered by the active ingredient-resistant seed traits 112 in the seed variety 104 that has been planted, the framework for seed trait verification 100 may generate output data 150 that includes one or more of a warning to a user that this application may be harmful to the crop in that field, or an instruction to stop with an application operation, or other types of management recommendations or notifications as noted further herein. The present invention may also be configured to check plantings in neighboring fields 115, regardless of whether the anticipated application 145 passes this check for the particular field 114. If there are plantings with a seed variety 104 that does not have the active ingredient-resistant seed trait needed for the anticipated application 145, seed trait verification 100 may generate output data 150 that includes a notice or warning to the user of a possible drift issue and damage to those plantings, and may suggest procedures, such as for example setback buffers, to avoid drift problems.

Input data 110 for the framework for seed trait verification 100 may include, as noted above, the selected or proposed herbicide, insecticide or pesticide 102, as well as specific active ingredients and amounts thereof that are present in the herbicide 102. Input data 110 also includes planting data 111, such as a seed variety 104, and resistance traits 112 of such seed varieties 104. Input data 110 also includes field data 113, which may include characteristics that identify a particular field 114 to which the anticipated application of herbicide 102 is being analyzed. Field data 113 may also include information identifying neighboring fields 115, and geo-positional or geo-spatial data such as Global Positioning System (GPS) information and/or other positional coordinates 116 or any other information or attributes that identify a particular field 114, neighboring fields 115, or other geographical location to which a selected herbicide 102 may be applied (as well as any specific field characteristics thereof). Input data 100 may also include weather data 117, including historical or expected weather conditions for the particular field 114 and/or neighboring fields 115, applicator-specific data 118, (for example the type of delivery mechanism and any particular characteristics, such as nozzle types, prior container usage, etc.), and prior crop treatment data 119.

The data processing modules 134 may include a data retrieval and initialization module 140, which is configured to retrieve, ingest, request, or otherwise obtain the input data 110, and initialize and distribute the input data 110 for the various other functions within the framework for seed trait verification 100 to validate and/or certify an anticipated application 145 of the herbicide 102. The data processing modules 134 also include a compatibility determination module 142, which is configured to process the input data 110 by identifying specific amounts 143 of active ingredients 106 and/or different types thereof, and performing calculations or mathematical manipulations to associate 144 a resistance of a seed variety with the specific amounts or types of active ingredients 106.

It is to be noted that the framework for seed trait verification 100 of the present invention performs seed trait analytics using calculations and/or mathematical manipulations at least in part because active ingredients 106, and the different amounts thereof, may have produce variances in chemical interactions and reactions between them when applied to a crop, depending on those specific amounts and the different types of active ingredients present. For example, one type of active ingredient 106 in a specific amount may react differently with an active ingredient 106 of a different type (or amount thereof), and therefore the present invention analyzes this information to ensure that different types and amounts of active ingredients are accounted for when an herbicide or herbicides 102 are applied to a particular field 114. Further, different herbicides 102 may be applied at different times, and in different combinations, and the active ingredients 106 in such herbicides 102 may linger in a planted field depending on weather and soil conditions, and such different active ingredients 106 applied at different times and under different conditions may remain harmful or active in varying stages of strength, potency or decay. Consequently, knowledge of the entirety of such applications may help an agronomist, grower, owner, applicator, or other responsible party effectively manage crop treatments applied throughout a growing season. The calculations may therefore include any number of formulas, equations, algorithms, or other mathematical manipulations that account for variances in such strength, potency and decay across different time periods, and the corresponding reactions and interactions when other active ingredients 106 are also present.

The compatibility determination module 144 applies these calculations and/or mathematical manipulations to determine whether the selected herbicide 102 is compatible with the planted seed variety 104, for enabling a crop treatment for the particular field 114, in the anticipated application 145 thereof. This information is used by a validation/certification module 146 to generate a resistance profile 148 that characterizes the anticipated application 145 of the selected herbicide 102 to the particular field 114 based on the compatibility of the selected herbicide 102 with the seed variety 104, and indicates whether the anticipated application 145 has been certified, validated or invalidated based on such a compatibility.

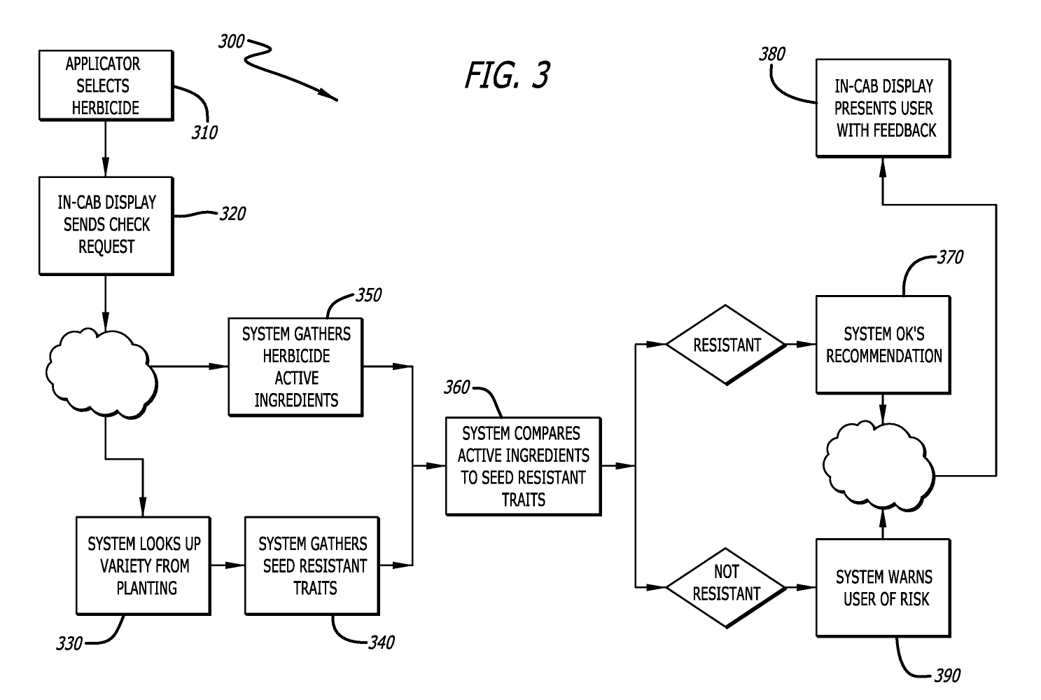

The framework for seed trait verification 100 generates output data 150 from one or both of the validation/certification module 146 and the resistance profile 148, and such output data 150 may take many different forms. Output data 150 may include stop/proceed operations instructions 152 or signals representing such instructions, whereby an anticipated application 145 of the selected herbicide 102 is controlled by either an instruction to stop the anticipated application 145, or proceed with the anticipated application 145. The present invention may be configured so that a stop instruction 152 is generated based on the resistance profile 148, where the seed variety 104 is not resistant to the selected herbicide 102 and therefore the anticipated application 145 of the selected herbicide 102 to the particular field 114 should not be initiated or completed. Conversely, a proceed instruction 152 may be generated from the resistance profile 148 where the seed variety 104 is resistant to the selected herbicide 102, and therefore the anticipated application 145 of the selected herbicide 102 to the particular field 114 may proceed as planned or scheduled. A user may respond to such output data 150 by manually stopping or proceeding with an application 145 of the herbicide 102 in the particular field 114, for example in response to an in-cab display as noted below with regard to FIG. 3, or an automated operation to stop or to proceed may be controlled based on the output data 150 relative to the anticipated application 145 of the selected herbicide 102 to the particular field 114.

Many other types of output data 150 are also possible and within the scope of the present invention. For example, one or more management recommendations, advisories or alerts 154 may be generated, such as a damage potential alert, a mitigation practices alert, or a localized rules compliance alert. Exemplary management recommendations 154 may further include applicator-specific instructions, such as a spray nozzle selection, a spray setting, and tank cleaning or flushing instructions. Regulatory, labeling, or rules compliance may be another specific type of output data 150, comprising for example a regulatory notification 156 to relevant authorities, or a notice to an applicator that a tank cleaning is required in compliance with particular rules or manufacturer requirements. Additionally, output data 150 may include a notification 158 to owners, growers, or other responsible entities for neighboring fields 115 which may be affected by spray drift or other consequential outcome from an application 145 of a selected herbicide 102.

One or both of the resistance profile 148 and the output data 150 may also be applied to an agronomic decision support tool 160 that is configured to allow access to one or more automated processes for agricultural decision-making and recommendation-writing, such as advising as to the type and timing of delivery of the herbicide 102. The agronomic decision support tool 160 also enables a user to input and/or select one or more variables that may define or augment the input data 110, such as for example manually defining boundaries of a particular field 114. The agronomic decision support tool 160 may include a function enabling an override which allows a user, for example a crop advisor, to override a stop or proceed instruction 152, input specific amounts of active ingredients 106, define field boundaries as noted above, and customize other data and processing functions for seed trait verification 100.

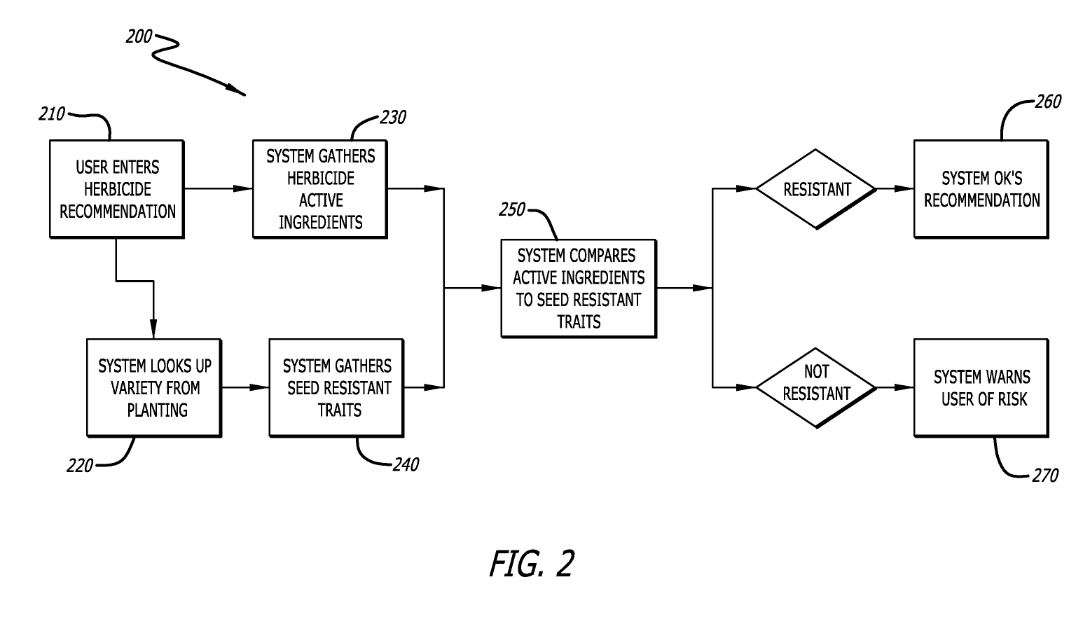

FIG. 2 is a block diagram illustrating aspects of seed trait verification 100 according to an exemplary embodiment of the present invention that provides a system and method for agronomist verification 200, in which a user enters a recommendation 210 for an anticipated application 145 of an herbicide 102. The agronomist verification framework 200 accesses a seed variety 104 in planting data 111 at block 220, and gathers seed resistance traits 112 at block 230 in the planted seed variety 104 as well as active ingredients 106 in the proposed herbicide 102 at block 240. The agronomist verification 200 then associates the active ingredients 106 with the seed resistance traits 112 at block 250, by performing seed trait analytics using the calculations and/or mathematical manipulations as above. If the seed variety 104 is resistant to the proposed herbicide 102, the framework for agronomist verification 200 outputs a recommendation at block 260 to proceed with the anticipated application 145. If the seed variety 104 is not resistant to the proposed herbicide 102, then the present invention outputs a warning at block 270 to the user of a risk with proceeding with the anticipated application 145. Where a warning is the output, the framework or agronomist verification 200 may include additional information, such as a “stop application” alert, or damage potential and mitigation practices, for example a timing and/or windows of application that may reduce the risk of contamination. Agronomist verification 200 may therefore incorporate, as noted above, information such as weather data 117, applicator-specific data 118, and prior crop treatment data 119 for generating information in its warning of risk.

FIG. 3 is a block diagram illustrating aspects of seed trait verification 100 according to an exemplary embodiment of the present invention that provides a system and method for applicator verification 300. In this embodiment, the present invention is a system and method that incorporates an in-vehicle or in-cab display system for in-field, real-time application operations. In this applicator verification framework 300, an applicator selects a proposed herbicide 102 at block 310, and the in-cab system communicates a verification request at block 320 that causes the present invention to look up a seed variety 104 in planting data 111 at block 330, and gathers seed resistance traits 112 in the planted seed variety 104 at block 340 as well as active ingredients 106 in the proposed herbicide 102 at block 350. The framework for application verification 300 then associates the active ingredients 106 with the seed resistance traits 112 at block 360, by performing seed trait analytics in the calculations and/or mathematical manipulations as above. If the seed variety 104 is resistant to the proposed herbicide 102, applicator verification 300 outputs a recommendation to proceed at block 370 with the anticipated application 145 and communicates this to the in-cab system for display to the applicator or user as feedback at block 380. If the seed variety 104 is not resistant to the proposed herbicide 102, then the framework for applicator verification 300 outputs a warning to the user of a risk with proceeding with the anticipated application 145 at block 390, and also communicates this to the in-cab system for display to the applicator or user as feedback.

It should be noted that in addition to or in lieu of in-vehicle or in-cab display systems, many other implementations are also possible and within the scope of the present invention. For example, applicator verification 300 may utilize mobile devices such as smart telephones or tablet computers or the like for in-field verification of the anticipated application 145 that evaluates planted seed varieties 104 and their resistance traits 112 with active ingredients 106 in a mobile setting, either inside of or outside of agricultural equipment. The applicator verification 300 of this embodiment may be initiated by a remote call, or may be run on the device itself. Regardless, it is to be understood that the present invention may be performed in conjunction with agricultural equipment and while a user or applicator is operating such equipment, either manually or remotely.

As with the agronomist verification 200, where a warning is the output, the present invention may include additional information, such as a “stop application” alert, or damage potential and mitigation practices, for example a timing and/or windows of application that may reduce the risk of contamination. The present invention may therefore incorporate information such as weather data 117, applicator-specific data 118, and prior crop treatment data 119 for generating information in its warning of risk.

In a further embodiment, seed trait verification 100 in the present invention may also analyze herbicide resistance data on seed varieties 104 planted in neighboring fields 115 to those of a particular field 114 to which an anticipated application 145 may occur. Seed trait verification 100 may then associate the active ingredients 106 and specific amounts thereof, and to account for interactions occurring between them (as well as the effect of different active ingredients 106 applied at different times and under different conditions), with the seed resistance traits 112 in the seed varieties 104 in those fields 115, and output a warning to the applicator, agronomist, or in-cab display (or directly to agricultural equipment 170, as noted further herein) that there is a risk of contamination or damage in the neighboring fields 115. Similarly, a “proceed” recommendation may also be generated as an output 150 where no risk to the neighboring fields 115 is determined because the planted seed variety 104 contains traits resistant to the herbicide 102 in the particular field 114 in the anticipated application 145.

As in the exemplary embodiments above, where a warning is the output, the seed trait verification framework 100 may include additional information, such as a “stop application” alert, tank cleaning instructions, and damage potential and mitigation practices, for example a timing and/or windows of application that may reduce the risk of contamination. The present invention may therefore incorporate information such as weather data 117, applicator-specific data 118, and past pesticide or other treatment applications 119 for generating information in its warning of risk.

Many examples of output warnings, advisories, and recommendations are possible and within the scope of the present invention. For example, where drift risk is a concern for neighboring or nearby fields 115, an advisory may be issued to warn the user of the risk to those fields 115 due to label-sensitive crops and weather conditions outside of the allowable label conditions that may lead to drift, and such an advisory may include preferred or non-preferred application time intervals. It is to be understood, in addition, that many factors may affect issues such as drift, and for which still more additional information may be needed. One such factor is geographical characteristics of the field 114 to be sprayed and of the neighboring fields 115, and examples of such geographical characteristics include recorded buffer strips, waterways, and environmentally-sensitive areas. Accordingly, the seed trait verification framework 100 of the present invention may access additional sources of information, either from third party sources directly or from other database collections, for example Global Positioning System (GPS) data (or other satellite-based radio-navigation data) and/or geo-spatial data for neighboring or nearby fields 115 to evaluate the relevance of such special geographical characteristics.

Where the present invention provides the output data 150 directly to agricultural equipment 170 for automated control of an application of an herbicide 102, the output data 150 may also include instructions that effect control of the agricultural equipment 170 to either continue with an application of the herbicide 102, stop the application of the herbicide 102, or adjust the application timing or delivery in some way. For example, the output data 150 may include information that enables a spray nozzle to be automatically changed on agricultural equipment 170, as needed to deliver the selected herbicide 102 in a manner consistent with the seed trait verification 100. Alternatively, the output data 150 may include information that enables the agricultural equipment 170 to speed up, slow down, or change direction as it progresses through a particular field 114. Output data 150 may therefore be configured to communicate directly with on-board controllers configured on agricultural equipment 170, or via a serial CAN (Controller Area Network) bus to on-board controllers. Regardless, it is to be understood that the present invention contemplates many ways in which the output data 150 may effect operational control of agricultural equipment 170 in response to a validation or invalidation of the anticipated application 145 of herbicide 102.

As noted above, the present invention may be configured to generate specific advisories, warnings, alerts, and recommendations as output data 150 from the seed trait verification framework 100. One such specific output involves the type of spray technique or device used in a herbicide or other chemical application, as well as the settings used. Such an output 150 may recommend or advise as to a particular selection of a spray nozzle, as well as nozzle settings such as pressure and spray pattern. This may result, at least in part, from the use of multiple herbicides 102 in the same tank or at the same time and with the same nozzle. Based on the herbicide 102 to applied (and also affected by other products that have been mixed with the herbicide 102), there may be a label-specified nozzle that needs to be used to reduce the risk of drift. In another example, the type of tank and the level of maintenance, flushing, or sanitation required for such a tank may also be the subject of an output 150 of the present invention. In such an example, an applicator, agronomist, or other user may be advised to use a particular tank cleaning procedure or flushing procedure (and type of liquid/solution used), both before and after application, based on the last product that was applied with the intended machine, due to or based on the sensitivity of the crop being applied to, and the pervious product that was applied using the same equipment or machinery.

It is to be understood that many other types of outputs 150 are contemplated within the seed trait verification framework 100, and therefore the present invention is not to be limited to any output 150 specifically mentioned herein. Examples of other outputs include those communicated to one or more additional components that allow application programming interfaces for performing additional processing regarding the anticipated application 145. Other outputs 150 may include guidance for university or academic review and analysis, and guidance for customized agronomic issues such as mitigating irrigation or spraying of other substances. Examples of such other outputs 150 include compliance with rules that may not be part of a particular label, but which may still be important, such as localized rules for certain geographical areas that are the result of court orders or legislative activity or public policy.

The seed trait verification framework 100 of the present invention may further include a machine learning or natural language processing component (or other language processing methods) that enables analyzing database collections and other relevant information for both the seed variety 104 and active ingredients 106 for names that may not be entered correctly, as well as foreign-language or translated names. The machine learning component may further be configured to be trained so as to learn how to evaluate reactions from interactions of different active ingredients 106 in different herbicides 102, and make automated recommendations for future crop treatments based on knowledge of historical treatments 119, seed varieties 104, resistance traits 112, and weather conditions 117.

The systems and methods of the present invention may be implemented in many different computing environments. For example, they may be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, and any comparable means. In general, any means of implementing the methodology illustrated herein can be used to implement the various aspects of the present invention. Exemplary hardware that can be used for the present invention includes computers, handheld devices, telephones (e.g., cellular, Internet enabled, digital, analog, hybrids, and others), and other such hardware. Some of these devices include processors (e.g., a single or multiple microprocessors), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be partially implemented in software that can be stored on a storage medium, non-transitory or otherwise, executed on programmed general-purpose computer with the cooperation of a controller and memory, a special purpose computer, a microprocessor, or the like. In these instances, the systems and methods of this invention can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, artificial intelligence, fuzzy logic, expert system or combination of hardware and software that is capable of performing the data processing functionality described herein.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. For example, the present invention may apply additional machine learning techniques, and/or other models, to convert observations into clusters for multi-band datasets. It is therefore intended that the scope of the invention be limited not by this detailed description. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A method, comprising:
receiving, as input data, a selected herbicide for an anticipated application in a particular field, information representing one or more active ingredients for the selected herbicide, planting data that includes a seed variety planted in the particular field, and seed resistance traits in the seed variety;
analyzing the input data in a plurality of data processing modules within a computing environment in which the plurality of data processing modules are executed in conjunction with at least one processor, the data processing modules configured to validate the anticipated application of the selected herbicide in the particular field, by:
identifying a specific amount of the one or more active ingredients to be delivered in the anticipated application of the selected herbicide in the particular field, associating a resistance of the seed variety to the specific amount of the one or more active ingredients from the seed resistance traits to determine a compatibility of the selected herbicide with the seed variety for enabling a crop treatment for the particular field, and generating a resistance profile characterizing the anticipated application of the selected herbicide to the particular field based on the compatibility of the selected herbicide with the seed variety; and
initiating a stop operation from the resistance profile characterizing the anticipated application of the selected herbicide to the particular field where the resistance profile characterizes the seed variety as not resistant to the selected herbicide, and a proceed operation from the resistance profile characterizing the anticipated application of the selected herbicide to the particular field where the resistance profile characterizes the seed variety as resistant to the selected herbicide, wherein a user stops or proceeds with an herbicide application in the particular field based on the anticipated application of the selected herbicide to the particular field, or an automated stop or proceed is controlled based on the anticipated application of the selected herbicide to the particular field.

2. The method of claim 1, further comprising generating, as output data, one or more recommendations, advisories, and alerts for the anticipated application of the selected herbicide.

3. The method of claim 2, wherein the output data includes one or more of a recommendation for a tank maintenance procedure and a liquid for cleaning or flushing a tank according to the tank maintenance procedure.

4. The method of claim 2, wherein the output data includes one or more of wait alert, a damage potential alert, and a mitigation practices alert for the anticipated application of the selected herbicide.

5. The method of claim 2, wherein the output data includes one or more of a localized rules compliance alert and a regulatory compliance alert.

6. The method of claim 2, wherein the output data includes a recommendation for one or more of spray nozzle selection and a spray setting, wherein the spray setting includes a spray pressure or a spray pattern.

7. The method of claim 1, further comprising receiving one or more of weather data relative to the particular field, applicator-specific data relative to a mode of application of the selected herbicide, and data relative to prior crop treatments for the particular field.

8. The method of claim 1, further comprising receiving geo-positional coordinates for one or more fields near the particular field, and additional input data representing a seed variety and seed resistance traits for crops planted in the one or more fields near the particular field.

9. The method of claim 8, further comprising generating, as output data, an advisory to a responsible entity for the one or more fields near the particular field of the anticipated application of the selected herbicide.

10. The method of claim 1, further comprising requesting the input data from an in-cab display configured on agricultural equipment.

11. The method of claim 1, wherein an instruction is communicated to agricultural equipment in response to the stop operation or the proceed operation.

12. The method of claim 11, wherein the instruction is displayed on an in-cab display configured on the agricultural equipment.

13. A system, comprising:
a computing environment including at least one non-transitory computer-readable storage medium having program instructions stored therein and a computer processor operable to execute the program instructions to validate an anticipated application of a selected herbicide in a particular field within a plurality of data processing components, the plurality of data processing components including:
a data retrieval and initialization component configured to receive, as input data, the selected herbicide for the anticipated application in the particular field, information representing one or more active ingredients for the selected herbicide, planting data that includes a seed variety planted in the particular field, and seed resistance traits in the seed variety;
one or more components configured to identify a specific amount of the one or more active ingredients to be delivered in the anticipated application of the selected herbicide in the particular field, associating a resistance of the seed variety to the specific amount of the one or more active ingredients from the seed resistance traits to determine a compatibility of the selected herbicide with the seed variety for enabling a crop treatment for the particular field, and generating a resistance profile characterizing the anticipated application of the selected herbicide to the particular field based on the compatibility of the selected herbicide with the seed variety; and
an output component configured to initiate a stop operation from the resistance profile characterizing the anticipated application of the selected herbicide to the particular field where the resistance profile characterizes the seed variety as not resistant to the proposed herbicide, and a proceed operation from the resistance profile characterizing the anticipated application of the selected herbicide to the particular field where the resistance profile characterizes the seed variety as resistant to the proposed herbicide, wherein a user stops or proceeds with an herbicide application in the particular field based on the anticipated application of the selected herbicide to the particular field, or an automated stop or proceed is controlled based on the anticipated application of the selected herbicide to the particular field.

14. The system of claim 13, wherein the output component is further configured to generate as output data one or more recommendations, advisories, and alerts for the anticipated application of the selected herbicide.

15. The system of claim 14, wherein the output data includes one or more of a recommendation for a tank maintenance procedure and a liquid for cleaning or flushing a tank according to the tank maintenance procedure.

16. The system of claim 14, wherein the output data includes one or more of wait alert, a damage potential alert, and a mitigation practices alert for the anticipated application of the selected herbicide.

17. The system of claim 14, wherein the output data includes one or more of a localized rules compliance alert and a regulatory compliance alert.

18. The system of claim 14, wherein the output data includes a recommendation for one or more of spray nozzle selection and a spray setting, wherein the spray setting includes a spray pressure or a spray pattern.

19. The system of claim 13, wherein the data retrieval and initialization component is further configured to receive one or more of weather data relative to the particular field, applicator-specific data relative to a mode of application of the selected herbicide, and data relative to prior crop treatments for the particular field.

20. The system of claim 13, wherein the data retrieval and initialization component is further configured to request the information representing one or more active ingredients for the selected herbicide, the planting data that includes a seed variety planted in the particular field, and the seed resistance traits in the seed variety in response to the selected herbicide.

21. The system of claim 13, wherein the data retrieval and initialization component is further configured to receive geo-positional coordinates for one or more fields near the particular field, and additional input data representing a seed variety and seed resistance traits for crops planted in the one or more fields near the particular field.

22. The system of claim 21, wherein the output component is further configured to generate, as output data, an advisory to a responsible entity for the one or more fields near the particular field of the anticipated application of the selected herbicide.

24. The system of claim 13, wherein the data retrieval and initialization component is further configured to request the input data from an in-cab display configured on agricultural equipment.

25. The system of claim 13, wherein an instruction is communicated to agricultural equipment in response to the stop operation or the proceed operation.

26. The system of claim 25, wherein the instruction is displayed on an in-cab display configured on the agricultural equipment.
